(19) United States
(12) Patent Application Publication
(10) Pub. No.: US 2013/0268848 A1
(43) Pub. Date: Oct. 10, 2013

(54) USER EVENT CONTENT, ASSOCIATED APPARATUS AND METHODS

(71) Applicants: Erich Jose Martino Peña, London (GB); Joseph Phillips, London (GB); Nicola Plaisant, Ulm (DE); Matt Turnbull, Nr. Cleobury Mortimer Kidderminster (GB)

(72) Inventors: Erich Jose Martino Peña, London (GB); Joseph Phillips, London (GB); Nicola Plaisant, Ulm (DE); Matt Turnbull, Nr. Cleobury Mortimer Kidderminster (GB)

(73) Assignee: NOKIA CORPORATION, Espoo (FI)

(21) Appl. No.: 13/440,568

(22) Filed: Apr. 5, 2012

(51) Int. Cl. G06F 17/00

(52) U.S. Cl. 715/255

(57) ABSTRACT

An apparatus comprises at least one processor; and at least one memory including computer program code, the at least one memory and the computer program code configured to, with the at least one processor, cause the apparatus to perform at least the following: enable the creation of a discrete journal comprising time-stamped user event content taken from a plurality of user applications, the discrete journal relating to a discrete journal timeframe and wherein the time-stamped user event content has time-stamps within the discrete journal timeframe.

### TECHNICAL FIELD

The present disclosure relates to the field of the organisation of user event content associated with a plurality of user applications, associated methods, computer programs and apparatus. Certain disclosed aspects/examples relate to portable electronic devices, in particular, so-called hand-portable electronic devices which may be hand-held in use (although they may be placed in a cradle in use). Such hand-portable electronic devices include so-called Personal Digital Assistants (PDAs) and tablet personal computers.

The portable electronic devices/apparatus according to one or more disclosed aspects/examples may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Electronic devices, such as a home computers, mobile telephones and tablet computers, may be used for many purposes via different user applications. For example, a user of a mobile telephone may use an in-built camera of the mobile telephone to take photos and/or movies using a camera/movie application. The user may send and receive different types of message (SMS, MMS and e-mail) using the mobile telephone and messaging applications. The user may also use the mobile telephone to play games via gaming applications, and view and update their social networking profiles using one or more social networking applications. Many other tasks may be performed using the mobile telephone and appropriate user applications/software.

When the user creates content, such as taking a new photo or composing a new e-mail, the time and/or date when the content was created may be stored. For example, if a user takes a photo with a digital camera, the photo may be stored alongside the time and date when the photo was taken. As another example, if a user replies to an e-mail then the time and date when the reply was transmitted may be included with the reply, so that, for example, the sender and recipient of the e-mail have a record of when the message was transmitted.

The listing or discussion of a prior-published document or any background in this specification should not necessarily be taken as an acknowledgement that the document or background is part of the state of the art or is common general knowledge.

### SUMMARY

In a first aspect, there is provided an apparatus, the apparatus comprising:
at least one processor; and
at least one memory including computer program code,
the at least one memory and the computer program code configured to, with the at least one processor, cause the apparatus to perform at least the following:
enable the creation of a discrete journal comprising time-stamped user event content taken from a plurality of user applications, the discrete journal relating to a discrete journal timeframe and wherein the time-stamped user event content has time-stamps within the discrete journal timeframe.

The (discrete) journal may be thought of as an electronic collection of items (such as, for example, e-mails, photographs, movies, calendar entries, location logs and new contacts) which can be displayed together to provide a memento of a particular period of time in the user's life.

The term “discrete journal” indicates that the journal relates to a particular period of time, that is, a discrete timeframe. Such a particular period/discrete timeframe may be one year, a school term, a weekend, or a three week holiday, for example. Over a user's lifetime, or over the lifetime of an electronic device and/or applications used by a user, there may be several “discrete journals” relating to different periods of time/discrete timeframes. For example, a user may have taken digital photographs over the last eight years, perhaps since first owning a digital camera. That user may have many discrete journals, each over different discrete periods of time, which together include some (or all) of the user's digital photographs taken/recorded over the last eight years.

Time-stamped user event content is content related with an event in a user's life which has an associated time-stamp. For example, a user may receive an SMS message from a contact. That message is user event content, as receipt of the SMS message is an event, related to the user as it was transmitted to the user, and the message has content (i.e. the content of the SMS message). The SMS message will have been transmitted (and received) at a particular time on a particular date, and the SMS message will have an associated time-stamp recorded with it according to the time and date at which it was received. As another example, a user may record their current location using a GPS enabled smartphone. The user's location is content (which may be the GPS coordinates, or latitude/longitude, for example) and the user has recorded the location, thus marking an event. The location will be recorded at a particular time and date and so the recorded location will have an associated time-stamp according to when that location was logged/recorded.

The discrete journal timeframe may be defined according to a user indicated discrete timeframe. For example, the user may be able to specify a discrete timeframe for the journal, such as the first two weeks in September 2012, 7-16 Aug. 2013, or 8 am-11:30 pm on 24 Dec. 2012, for example.

The discrete journal timeframe may be defined according to user indicated start and end time points. The user may be able to indicate the start and end time points to define the start and end of a discrete journal timeframe. For example, the user may choose 6 pm Saturday 24 Mar. 2012 as a start time point and choose 6 pm Sunday 25 Mar. 2012 as an end time point for the discrete journal. The discrete journal may then comprise time-stamped user event content associated with the 24 hour time period defined by those start and end points. The user may, for example, be attending a concert with friends on the evening of the 24 Mar. 2012 and wish to create a discrete journal to record her time at the concert and at a party after. Time points may also be defined as dates, rather than times. This may be more appropriate, for example, if the user wishes to define a journal for a longer period of time such as a school term. The time at which the journal timeframe begins may then be 00:00 on the morning of the date used to define the start time point, and the end of the journal timeframe may be 12:00 midnight on the evening of the dates used to define the end time point.

The discrete journal timeframe may be defined according to a user indication which provides one or more discrete time points which define a discrete timeboundary to encompass events which occur within the discrete timeboundary, in the life of a user, the events being captured by one or more of the plurality of user applications to provide time-stamped user event content.

The apparatus may be configured to enable the creation of the discrete journal by receipt of an indication of a future discrete journal timeframe, the future discrete journal timeframe associated with a time period in the future with respect to the time at which the indication is received. For example, the current date may be 1 Aug. 2012, and the user may wish to record a discrete journal for a winter holiday booked for 18-28 Nov. 2012. The user may be able to create this “future” journal, which will become a current journal upon the date reaching 18 Nov. 2012.

The apparatus may be configured to automatically populate the discrete journal with the time-stamped user event content taken from the plurality of user applications upon commencement of the indicated future discrete journal timeframe. In the example above, the user (in August 2012) has created a journal for 18-28 Nov. 2012. Upon the date reaching 18 Nov. 2012, the apparatus may be configured to automatically populate the discrete journal with time-stamped user event content taken from a plurality of user applications. For example, after the start of the discrete journal timeframe (that is, upon the date reaching 18 Nov. 2012 (but not after 28 Nov. 2012 which is the end time point of the journal)), if the user takes a photo, sends/receives an e-mail, updates a social media status, posts a blog entry, updates a music playlist, records a new contact in an electronic address book, or saves a new bookmark in an e-book, then this user-event content (the photo, e-mail, status update, blog text, music playlist, new contact details and bookmark details) will be time-stamped as having occurred within the discrete journal timeframe and may be included in the discrete journal. In this way the user can automatically create a journal record of his or her November holiday.

The apparatus may be configured to automatically complete population of the discrete journal with the time-stamped user event content taken from the plurality of user applications upon completion of the indicated future discrete journal timeframe. Again looking at the November holiday example above, upon the date reaching the 28 Nov. 2012 (the end of the discrete journal timeframe), the discrete journal will no longer be populated with time-stamped user event content since any user event content being recorded after 28 Nov. 2012 will be time-stamped with a time stamp outside (after) the discrete journal timeframe.

In other examples, the user may be able to adjust the start and end time points of the discrete journal to shift, expand or contract the journal timeframe. This may be done before reaching the start of the journal timeframe, or may be done after the journal has begun to be populated with time-stamped user event content, or may be done after the end of the discrete journal timeframe has passed. For example, if the user extends their holiday they may wish to move the end time point from 28 Nov. 2012 to 30 Nov. 2012. The apparatus may be configured to automatically re-populate the discrete journal with time-stamped user event content to include content time-stamped between 28 and 30 Nov. 2012, in this example.

In another example, the user may have re-scheduled their holiday to start on 23 Nov. 2012, and so wish to move the start time point from 18 Nov. 2012 to 23 Nov. 2012. The apparatus may be configured to automatically re-populate the discrete journal with time-stamped user event content to include only content time-stamped between 23 and 30 Nov. 2012, and therefore remove or leave out any time-stamped user event content which has previously been included as being time-stamped between 18-23 Nov. 2012, for example.

The apparatus may be configured to automatically populate the discrete journal with the time-stamped user event content taken from the plurality of user applications upon commencement of the discrete journal timeframe. Upon reaching the start of the journal timeframe, the apparatus may be configured to automatically detect the creation/availability of time-stamped user event content and include that time-stamped user event content in the discrete journal.

The apparatus may be configured to receive an indication of the discrete journal timeframe by receipt of a start of the discrete journal timeframe. A discrete journal may be defined by the definition of a start time point and not necessarily at the same time with an end time point also. For example, a user may know that they are going to visit a foreign country, but not know how long they will be staying until later in their stay. In this case a user could create a discrete journal for that trip by specifying a start time point (such as the day of departure) and they may be able to leave the discrete journal open-ended until a later date when they know when they will return home, for example, or even after they have returned home after their trip.

The apparatus may be configured to receive an indication of an end of the discrete journal timeframe after the commencement of the discrete journal timeframe. In the example above of a user creating an open-ended journal, the user may, once having stayed abroad for a while, decide to return home and wish to end their discrete journal on the date on which they return home. Thus the user can indicate to the apparatus the date at which they wish to end the discrete journal recording user events from their holiday, part way through the holiday (i.e. part way through the timeframe of the discrete journal) and after the journal has begun to be populated with time-stamped user event content.

The apparatus may be configured to populate the discrete journal with the time-stamped user event content upon detection of a particular user input. The apparatus may allow a user to update the user event content included in the journal by the user making a particular user input. For example, the user may be able to manually remove or include time-stamped user event content which was not included by the apparatus automatically. For example, the apparatus may be configured to include only photographs, movies, and sound recordings in a particular discrete journal. A user may wish to include one particular received e-mail (and not all e-mails received having a time-stamp within the timeframe of the discrete journal). The user may be able to manually include that e-mail of interest by performing a particular user input detected by the apparatus, without necessarily having to include all e-mails time-stamped within the journal timeframe. Such a user input may be selecting a menu option to include an individual item of user event content, for example.

The apparatus may be configured to populate the discrete journal with the time-stamped user event content upon detection of the availability of the time-stamped user event content within the discrete journal timeframe. That is, the apparatus may be able to detect the availability of time-stamped user event content, for example, by detecting each time a new item of user event content is recorded by the apparatus. The apparatus may be configured to detect, for example, new social media and blog posts, and include these newly detected posts in a discrete journal if they are time-stamped with a time stamp within the timeframe of the discrete journal. Thus the apparatus may be able to automatically populate the journal with time-stamped user event content as that content is detected as being available (i.e. saved on a local or remote memory accessible by the apparatus).

The apparatus may be configured to enable the time-stamped user event content to be displayed in the discrete journal timeframe on an electronic device. The discrete journal may be displayed, for example, on the display screen of a laptop or desktop computer, on a tablet computer display screen, on the display screen of a mobile telephone or smartphone, or on the display of any other electronic device. The apparatus may or may not be one of these devices. The journal, and user event content within the journal, may be displayed with a resolution suitable for display on both portrait and landscape modes on an electronic device. User event content may appear differently when displayed in a portrait orientation, as compared with landscape orientation.

The apparatus may be configured such that the discrete journal timeframe is defined by one or more of a user and the apparatus.

The apparatus may be configured to detect that the location of the apparatus has changed beyond a predetermined threshold, and upon detection, offer an option to a user to create a new discrete journal. Beyond a predetermined threshold may be, for example, the apparatus changing location to a location which is out of the ordinary, for example, a different country, or a different region within the same country, compared with a usual location. Beyond a predetermined location may, in other examples, be a change of location within a preset period of time by a distance exceeding a predetermined distance threshold. For example, the user's location may change beyond a predetermined threshold if they have travelled somewhere for a special event, and the user may wish to create a journal to record user event content relating to that special event. The apparatus may detect that the user and apparatus have changed location and offer the option of creating a new discrete journal so that the user can record user event content relating to the special event in a journal.

The apparatus may be configured to detect that the amount of time-stamped user event content made newly available to the apparatus in a predetermined period is higher than a predetermined threshold, and upon detection, offer an option to a user to create a new discrete journal having a journal timeframe including the predetermined period. An increased volume of content (e.g. compared with a usual average volume of content) being recorded over a particular time period may indicate that the user is more actively recording user event content and thus that particular period of increased activity may be a period of time which the user wishes to record using a discrete journal. The time-stamped user event content may be all types of user event content, or one or more particular types of user event content.

One example is that the time-stamped user event content is photographic content in particular, and the user may be taking more photographs than usual (for example, if they are at a concert or party). The journal may be configured to have a predetermined threshold of 10 photographs per day (the day being the predetermined period). Thus, if the user takes more than 10 photographs in one day, the apparatus may detect this increased level of new photographic user event content availability as an indication of the user undertaking a special activity. The apparatus can accordingly offer to create a new discrete journal having a timeframe including the period of time over which a higher number of photographs has been recorded. Of course, the predetermined threshold may be more, or less, than 10 photographs (or other types of user event content). Further, the particular time period may be longer, or shorter, than one day. Both the predetermined threshold and the particular time period may be predefined settings of the apparatus or may be user-defined settings.

The apparatus may be configured to organise the time-stamped user event content within the discrete journal timeframe by one or more of:
time-stamped in groupings according to the particular user event content type independent of the particular application from which the user event content was obtained;
time-stamped in groupings according to the particular application from which the user event content was obtained; and
chronologically grouped according to the time stamp of the time-stamped user event content independent of the particular application from which the user event content was obtained.

Time-stamped user event content may be displayed in different orders. It may be displayed with groups of user event content of the same type (e.g. photographs, e-mails, blog posts, bookmarks) being shown together. A particular type of user event content may be associated with more than one user application. For example, e-mails may be received to two different user accounts. These e-mails in the discrete journal may be displayed all together as “e-mails” or may be split into being displayed in two groups; one group as “e-mails, application A” and another group as “e-mails, application B”.

The user event content with these type-groups may be in chronological (or reverse chronological) order within each type sub-group. Time-stamped user event content may be displayed in chronological (or reverse chronological) order regardless of what type of user event content and/or associated user application the content has. For example, all user event content having a time-stamp of 6 Jun. 2013 may be grouped together in the journal regardless of the type of content as being time-stamped on 6 Jun. 2013. The content in this 6 Jun. 2013 group may be ordered within the group according to content type, associated user application, and/or time-stamp (such that, an event time-stamped at 11:45 am 6 Jun. 2013 will appear before an event time-stamped at 11:50 am on 6 Jun. 2013).

The apparatus may be configured to allow a user to select the particular user applications from which the discrete journal will be created. The user may only wish to include, for example, e-mails, photographs and movies in a particular journal. Different journals of the same user, available on the same apparatus/device, may include different types of content. For example, the user may have a discrete journal for a party, and include only photographs and movies. The same user may have another discrete journal for a school holiday, and may wish to include photographs, movies, e-mails, messages, bookmarks, playlists, contacts, games, social media updates and calendar entries.

The discrete journal may be one of a plurality of discrete journals. Each of the plurality of discrete journals may have at least partially different journal timeframes associated with a particular user.

The time-stamped user event content may be time-stamped according to at least one of the time of creation, receipt, transmission, modification and/or sharing of the time-stamped user event content.

The time-stamped user event content type may be one or more of: a photograph, a movie, a sent or received short message, a sent or received e-mail, a sent or received chat message, a music file, a created file, a saved file, a status update, a website post, contact information, game-related content, a playlist, a calendar entry, a map location, and a bookmark.

The apparatus may be configured to indicate a discrete journal by displaying a journal indicator, the journal indicator comprising one or more of an image, a textual label, an icon, a button, banner or menu option taken from or respectively formed using the user event content, or an icon, a button, a banner, an image, a textual label and a menu option.

The apparatus may be configured such that the relative size of the journal indicator for a discrete journal corresponds to one or more of:
the amount of time-stamped user event content associated with the discrete journal;
the amount of user activity associated with the discrete journal;
the journal timeframe of the discrete journal;
an indicated importance level of the discrete journal; and
a predefined user setting associated with the journal.

The apparatus may be configured to enable transmission of the discrete journal to a remote electronic device. A user may be able to transmit/send a journal to another electronic device/apparatus and to another user. For example, if the user has a discrete journal for a rock concert which they attended with friends, they may wish to share that journal with the friends who they went to the concert wish. Sharing may be giving the other user's a password to that they can log into a particular user application and view the user's discrete journal, or may be transmission of the journal to the user.

Whether the journal is transmitted from the user to another user, or is not shared/transmitted and remains on a device of the user, the time-stamped user event content and the discrete journal may not necessarily be stored on the same memory/device. The journal may be stored, for example, on a memory of a portable electronic device, while the time-stamped user event content may be stored on a server remote to the portable electronic device, but accessible to the portable electronic device so that the user can see the journal. Transmitting a journal may not involve transmitting all the user event content associated with that journal, if the user event content is remotely stored and accessed by the device having/displaying the journal.

Further, if a user deletes/removes an item of user event content from a journal, it may not be the case that that item of user event content is deleted completely, but it may just be removed from display by or association with the journal. For example, if a user wishes to remove a particular photograph from a journal, deletion of that photograph may not delete the photograph entirely, and may only remove that photograph from display in that particular journal. If the user were to, for example, use the apparatus file directory or a photograph user application to view the photographs available to the user, the photograph removed from the journal may still be available in the directory/application.

The apparatus may be configured to create the journal by the apparatus or by an apparatus remote to the apparatus. That is, the apparatus itself may create the journal, or the apparatus may communicate with a remote apparatus to create the journal. For example, a portable electronic device (the apparatus or comprising the apparatus) may communicate with a remote server, the remote server may store the user event content, and the portable electronic device may access the content stored on the remote server in order to create the journal (or vice versa).

The plurality of user applications may be a plurality of independent user applications. That is, the user applications associated with the time-stamped user event content may be completely independent from each other. The user applications from which user event content is taken to populate the discrete journal may be, for example, a standalone movie application, a standalone photograph application, two different e-mail clients, an SMS messaging client, and an e-book application, all of which do not necessarily communicate with one another, but from which the apparatus is able to take user event content for use in a journal. The applications may or may not be stored/run locally with the apparatus.

The apparatus may be a portable electronic device, a mobile telephone, a smartphone, a tablet computer, a personal digital assistant, a laptop computer, a media player, a non-portable electronic device, a desktop computer, a server, or a module/circuitry for one or more of the same.

In another aspect, there is provided a method, the method comprising:
creating a discrete journal comprising time-stamped user event content taken from a plurality of user applications the discrete journal relating to a discrete journal timeframe and wherein the time-stamped user event content has time-stamps within the discrete journal timeframe.

In another aspect, there is provided a method, the method comprising:
enabling the creation of a discrete journal comprising time-stamped user event content taken from a plurality of user applications the discrete journal relating to a discrete journal timeframe and wherein the time-stamped user event content has time-stamps within the discrete journal timeframe.

In another aspect there is provided a computer readable medium comprising computer program code stored thereon, the computer readable medium and computer program code being configured to, when run on at least one processor, perform at least the following:
enable the creation of a discrete journal comprising time-stamped user event content taken from a plurality of user applications, the discrete journal relating to a discrete journal timeframe and wherein the time-stamped user event content has time-stamps within the discrete journal timeframe.

The computer program may be stored on a storage media (e.g. on a CD, a DVD, a memory stick or other non-transitory medium). The computer program may be configured to run on a device or apparatus as an application. An application may be run by a device or apparatus via an operating system.

In another aspect, there is provided an apparatus, the apparatus comprising::
means for enabling the creation of a discrete journal comprising time-stamped user event content taken from a plurality of user applications the discrete journal relating to a discrete journal timeframe and wherein the time-stamped user event content has time-stamps within the discrete journal timeframe.

The present disclosure includes one or more corresponding aspects, examples or features in isolation or in various combinations whether or not specifically stated (including claimed) in that combination or in isolation. Corresponding means and corresponding functional units (e.g. discrete journal creator, discrete journal creation enabler, timestamp recorder) for performing one or more of the discussed functions are also within the present disclosure.

Corresponding computer programs for implementing one or more of the methods disclosed are also within the present disclosure and encompassed by one or more of the described examples.

### BRIEF DESCRIPTION OF THE FIGURES

A description is now given, by way of example only, with reference to the accompanying drawings, in which:

FIG. 1 illustrates an example apparatus according to the present disclosure;

FIG. 2 illustrates another example apparatus according to the present disclosure;

FIG. 3 illustrates a further example apparatus according to the present disclosure;

FIG. 4 illustrates a timeline with discrete journal timeframes;

FIGS. 5a-5b illustrate the display of discrete journals by journal indicators;

FIGS. 6a-6b illustrate time-stamped user event content having timestamps within a discrete journal timeframe, organised by date and by content type;

FIGS. 7a-7d illustrate discrete journals with future discrete journal timeframes;

FIGS. 8a-8b illustrate an example apparatus in communication with a remote server/cloud;

FIG. 9 illustrates an example method according to the present disclosure; and

FIG. 10 illustrates schematically a computer readable medium providing a program.

### DESCRIPTION OF EXAMPLE ASPECTS/EXAMPLES

Other examples depicted in the figures have been provided with reference numerals that correspond to similar features of earlier described examples. For example, feature number 100 can also correspond to numbers 400, 500, 600 etc. These numbered features may appear in the figures but may not have been directly referred to within the description of these particular examples. These have still been provided in the figures to aid understanding of the further examples, particularly in relation to the features of similar earlier described examples.

A user of an electronic device, such as a home computer, mobile telephone, smartphone or PDA, may use that device for many purposes. Different user applications available for use on the device allow the user to perform different tasks. For example, a user of a mobile telephone may use an in-built camera of the mobile telephone to take photos and/or movies using a camera/movie application. The user may send and receive different types of message (SMS, MMS and e-mail) using the mobile telephone and messaging applications. The user may also use the mobile telephone to play games via gaming applications, or view and update their social networking profiles using one or more social networking applications. Many other tasks may be performed using the mobile telephone and appropriate user applications/software.

When the user creates content (takes a photo, writes an SMS, creates a new contact in an address list, or reaches a new level in a video game, for example), the time and/or date when the content was created may be stored. For example, if a user takes a photo with a digital camera, the photo may be stored alongside the time and date when the photo was taken. As another example, if a user replies to an SMS then the time and date when the reply was transmitted may be included with the reply. If the user creates a new contact in an address book, then the time and date when that contact was created may be logged. If a user reaches the next level in a video game, the time and date when the new level was reached may be recorded.

A user may be able to organise their content using the recorded times/dates associated with that content. For example, a user may be able to organise the photos stored on their home computer by date, or a user can organise the e-mails they have written in date order. Such organisation can help a user to find content of interest (for example, if the user wants to find photographs/movies which they took at Christmas time, they may wish to look for photographs/movies which have an associated date of the 25^{th} December). Or, as another example, a user may wish to look at e-mails and/or SMS messages which were sent to and/or received by the user around the time of an important meeting, for example.

A user may wish to look at different content based around a particular date (e.g. their birthday), or within a particular date period (e.g. within the start and end dates of their summer holiday). A user may use a photo user application to search for photographs taken on a particular date or dates, use their e-mail application to look for e-mails sent and/or received on a particular date or dates, and log into their social media application(s) and search for events logged on a particular date or dates.

If the user has an event planned for the future, such as a wedding or exotic holiday, then the user may wish to identify and group together photos, movies, and messages, for example, recorded during that future event into a neat format so that the user has a record of the event.

FIG. 1 shows an apparatus 100 comprising a processor 110, memory 120, input I and output O. In this example only one processor and one memory are shown but it will be appreciated that other examples may utilise more than one processor and/or more than one memory (e.g. same or different processor/memory types). The apparatus 100 may be an application specific integrated circuit (ASIC) for a portable electronic device. The apparatus 100 may also be a module for a device, or may be the device itself, wherein the processor 110 is a general purpose CPU and the memory 120 is general purpose memory.

The input I allows for receipt of signalling to the apparatus 100 from further components. The output O allows for onward provision of signalling from the apparatus 100 to further components. In this example the input I and output O are part of a connection bus that allows for connection of the apparatus 100 to further components. The processor 110 is a general purpose processor dedicated to executing/processing information received via the input I in accordance with instructions stored in the form of computer program code on the memory 120. The output signalling generated by such operations from the processor 110 is provided onwards to further components via the output O.

The memory 120 (not necessarily a single memory unit) is a computer readable medium (such as solid state memory, a hard drive, ROM, RAM, Flash or other memory) that stores computer program code. This computer program code stores instructions that are executable by the processor 110, when the program code is run on the processor 110. The internal connections between the memory 120 and the processor 110 can be understood to provide active coupling between the processor 110 and the memory 120 to allow the processor 110 to access the computer program code stored on the memory 120.

In this example the input I, output O, processor 110 and memory 120 are electrically connected internally to allow for communication between the respective components I, O, 110, 120, which in this example are located proximate to one another as an ASIC. In this way the components I, O, 110, 120 may be integrated in a single chip/circuit for installation in an electronic device. In other examples, one or more or all of the components may be located separately (for example, throughout a portable electronic device such as devices 200, 300, or within a network such as a “cloud” and/or may provide/support other functionality).

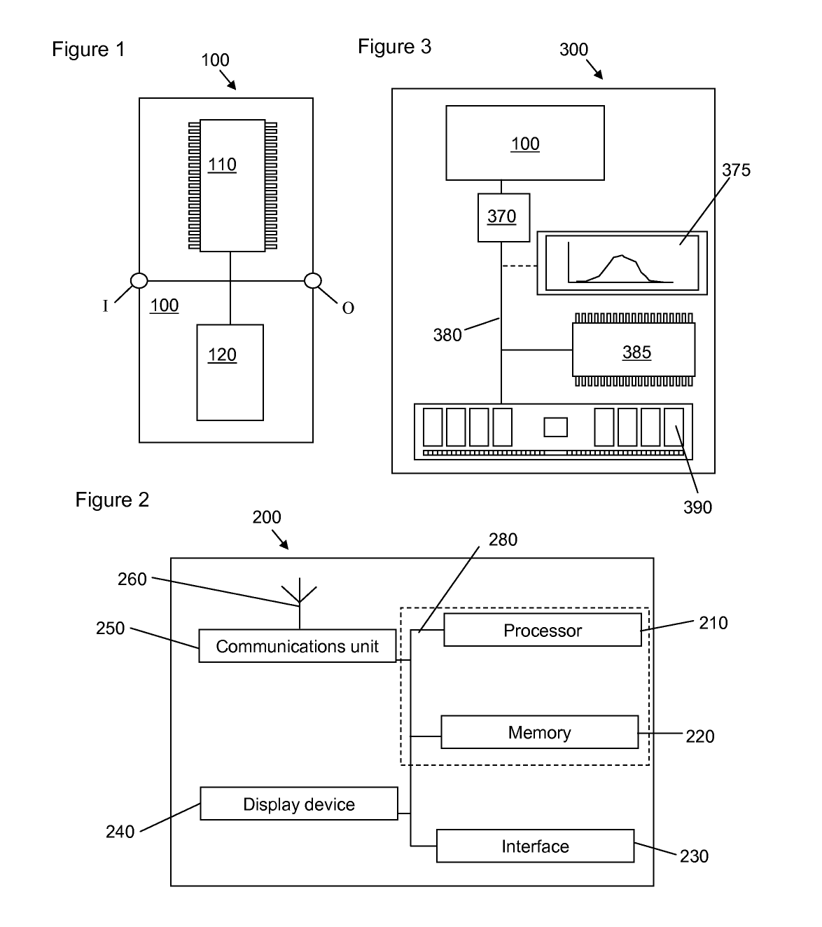

One or more examples of the apparatus 100 can be used as a component for another apparatus as in FIG. 2, which shows a variation of apparatus 100 incorporating the functionality of apparatus 100 over separate components. In other examples the device 200 may comprise apparatus 100 as a module (shown by the optional dashed line box) for a mobile phone or PDA or audio/video player or the like. Such a module, apparatus or device may just comprise a suitably configured memory and processor.

The example apparatus/device 200 comprises a display 240 such as, a Liquid Crystal Display (LCD), e-Ink, or touch-screen user interface (like a tablet PC). The device 200 is configured such that it may receive, include, and/or otherwise access data. For example, device 200 comprises a communications unit 250 (such as a receiver, transmitter, and/or transceiver), in communication with an antenna 260 for connection to a wireless network and/or a port (not shown). Device 200 comprises a memory 220 for storing data, which may be received via antenna 260 or user interface 230. The processor 210 may receive data from the user interface 230, from the memory 220, or from the communication unit 250. Data may be output to a user of device 200 via the display device 240, and/or any other output devices provided with apparatus. The processor 210 may also store the data for later user in the memory 220. The device contains components connected via communications bus 280.

The communications unit 250 can be, for example, a receiver, transmitter, and/or transceiver, that is in communication with an antenna 260 for connecting to a wireless network and/or a port (not shown) for accepting a physical connection to a network, such that data may be received via one or more types of network. The communications (or data) bus 280 may provide active coupling between the processor 210 and the memory (or storage medium) 220 to allow the processor 210 to access the computer program code stored on the memory 220.

The memory 220 comprises computer program code in the same way as the memory 120 of apparatus 100, but may also comprise other data. The processor 210 may receive data from the user interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

Device/apparatus 300 shown in FIG. 3 may be an electronic device (including a tablet personal computer), a portable electronic device, a portable telecommunications device, or a module for such a device. The apparatus 100 can be provided as a module for device 300, or even as a processor/memory for the device 300 or a processor/memory for a module for such a device 300. The device 300 comprises a processor 385 and a storage medium 390, which are electrically connected by a data bus 380. This data bus 380 can provide an active coupling between the processor 385 and the storage medium 390 to allow the processor 385 to access the computer program code.

The apparatus 100 in FIG. 3 is electrically connected to an input/output interface 370 that receives the output from the apparatus 100 and transmits this to the device 300 via data bus 380. Interface 370 can be connected via the data bus 380 to a display 375 (touch-sensitive or otherwise) that provides information from the apparatus 100 to a user. Display 375 can be part of the device 300 or can be separate. The device 300 also comprises a processor 385 that is configured for general control of the apparatus 100 as well as the device 300 by providing signalling to, and receiving signalling from, other device components to manage their operation.

The storage medium 390 is configured to store computer code configured to perform, control or enable the operation of the apparatus 100. The storage medium 390 may be configured to store settings for the other device components. The processor 385 may access the storage medium 390 to retrieve the component settings in order to manage the operation of the other device components. The storage medium 390 may be a temporary storage medium such as a volatile random access memory. The storage medium 390 may also be a permanent storage medium such as a hard disk drive, a flash memory, or a non-volatile random access memory. The storage medium 390 could be composed of different combinations of the same or different memory types.

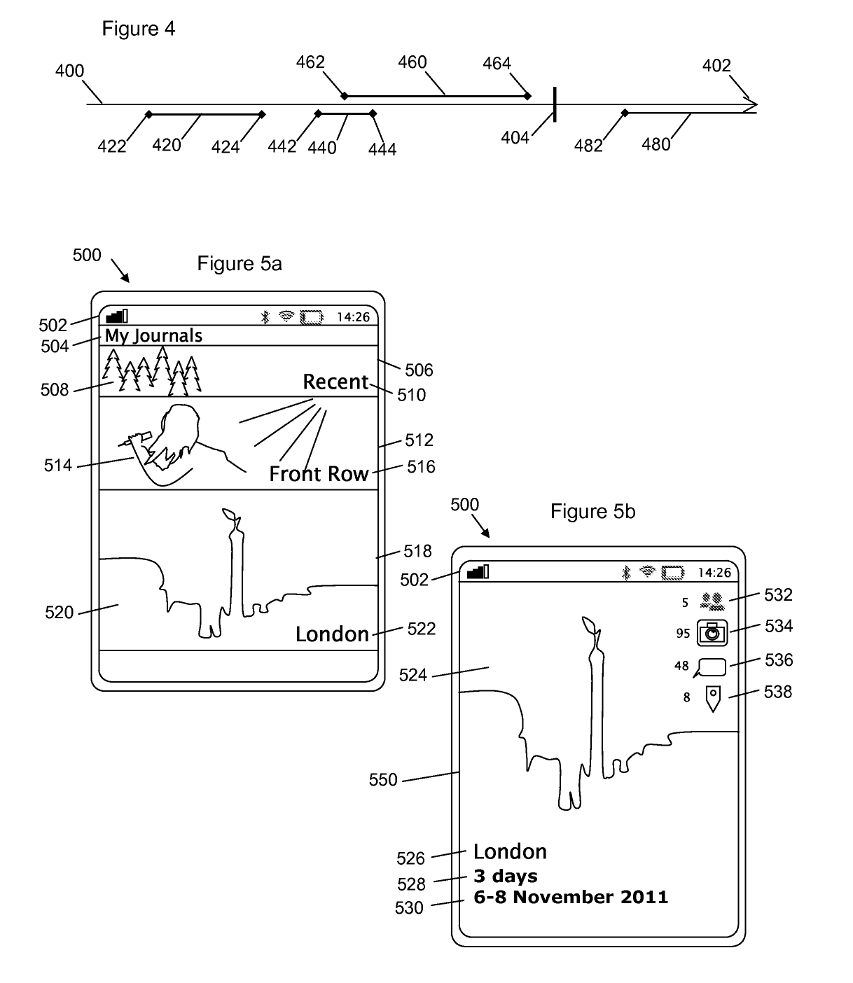

FIG. 4 illustrates a timeline 400, for example which starts on the date when a user was born. Time advances from left to right, and the timeline is ongoing (i.e. has no end date) as indicated by the arrow at the current end of the timeline 402. Along the timeline, that is, within the lifetime of the user so far, are discrete periods 420, 440, 460, 480. Discrete period 420 starts at time point 422 and end at time point 424, discrete period 440 starts at time point 442 and end at time point 444, discrete period 460 starts at time point 462 and end at time point 46, and discrete period 480 starts at time point 482 and has no fixed end time point. Discrete period 480 ends at the current time, and therefore period 480 will become longer in time as time progresses, until a fixed end time point is specified for period 480.

Each discrete period 420, 440, 460, 480 on the timeline represents a discrete journal timeframe. Therefore, the discrete journal timeframe for the journal associated with period 420, for example, is defined as starting at time point 422 and ending at time point 424. Another way of considering how discrete periods 420, 440, 460, 480 are defined is to consider each discrete journal timeframe 420, 440, 460, 480 as having one or more discrete time points which define a discrete timeboundary. For example, discrete period 440 (which represents a discrete journal timeframe) may be considered to be a discrete timeboundary, having a discrete start time point 442, and a discrete end time point 444. As another example, discrete period 480 (which represents a discrete journal timeframe) may be considered to be a discrete timeboundary having a discrete start time point 482, and a discrete end time point as the current date and time (which will change as time progresses). A discrete static end time point may be defined for discrete timeboundary 480 at some point in the future. A discrete journal timeframe may be defined as a future discrete journal timeframe relating to a period of time in the future. The marker 404 represents the current time/date. Thus discrete journal timeframe 480 is a discrete future journal timeframe. Of course, other discrete future journal timeframes may have both defined start and end dates.

A journal may be considered to be a collection of records of events occurring within a particular period of a user's life. A journal (a diary) in the traditional sense may be thought of as a book in which a user writes about events happening in their life so that they have a record of what they have done. A user may choose to stick photographs, concert tickets, notes and postcards, for example, into a traditional journal so the user has a scrapbook-like record, often in approximate date order, of events that have happened to them in their life. A user may keep separate such journals, for example, a separate journal may be kept for each year. As another example, a user may keep a journal over a holiday/vacation, or may keep a journal over a school term. The year, holiday/vacation, or school term are each discrete periods of time in the user's life.

Modern electronic devices can record content from many different sources. For example, a smartphone may be able to record photographs and movies, send/transmit SMS, MMS and e-mail messages, allow access to one or more social networking sites so that a user can update and view their profile, allow access to the internet, allow a user to play games, update and view an address book of contacts, and provide a user with other functionality. These different functionalities are associated with different user applications. For example, a user may record a movie using a movie-making application, and may send SMS messages using an SMS-messaging user application. When content is recorded or modified, the time and date when the creation/modification occurred is often recorded. For example, if a status update is posted on a social media website, the time and date of posting will also be recorded. Such content may be called time-stamped content, since it has an associated time-stamp. In the context of the content relating to an event in a user's life (such as a photo of the user with their friends, a message sent to the user, a movie recorded by the user, a blog entry made by the user, or a location logged of where a user has been), then such content may be labelled time-stamped user event content.

Thus, for example, a user may use an apparatus configured to enable the creation of a discrete journal comprising time-stamped user event content taken from a plurality of user applications. That is, an electronic journal relating to a discrete period of time (e.g. a school holiday) may be created, and may include time-stamped user event content (such as photos taken by the user during the school holiday, and e-mails written and received by the user during the school holiday). Such content may be taken from a plurality of applications (the photo may be taken using a photo user application, and the e-mails may be written in an e-mail client user application). The discrete journal relates to a discrete journal timeframe (the timeframe over the school holiday). The time-stamped user event content (e.g. photos, e-mails) has time-stamps within the discrete journal timeframe (e.g. the photos are time-stamped with a time within the period of the school holiday).

The discrete journal timeframe may be defined according to a user indicated discrete timeframe. For example, the user may input into an apparatus that they plan to go on holiday from 6-18 Mar. 2013. 6-18 Mar. 2013 is a discrete timeframe and is used to define a discrete journal timeframe. The journal can be used to record user event content which is time-stamped as being created/modified within the discrete timeframe defined by the user. The user may, for example, indicate start (6 Mar. 2013) and end (18 Mar. 2013) time points to define the discrete journal timeframe.

In other words, the discrete journal timeframe (6-18 Mar. 2013) may be defined according to a user indication which provides one or more discrete time points (a start time point of 6 Mar. 2013 and an end point of 18 Mar. 2013) which define a discrete timeboundary (6-18 Mar. 2013) to encompass events which occur within the discrete timeboundary, in the life of a user.

Revisiting FIG. 4, the discrete journals 420, 440, 460, 480 in the plurality of discrete journals each have at least partially different timeframes. The journal timeframes 440 and 460 partially overlap. It may be that the journal associated with journal timeframe 440 relates to a birthday weekend of the user, and the journal associated with journal timeframe 460 relates to a summer holiday which the user took, the holiday starting before the end of the birthday weekend. Each of the illustrated journal timeframes 420, 440, 460 480 is associated with a particular user. For example, four journals each associated with a respective journal timeframe may be located on the mobile telephone of a user and all four journals may be set up by him/her and pertain to events in his/her life.

FIGS. 5a-5b illustrate an example of an apparatus in use. The apparatus is a portable electronic device 500 such as a mobile telephone, tablet computer, smartphone or PDA. The device 500 is displaying a status bar 502 including exemplary information such as the received signal strength (in the examples of telephone devices), Bluetooth® connectivity, battery power remaining, and the current time. The device 500 in FIGS. 5a and 5b is also displaying at least one journal indicator 506, 512, 518, 500.

In FIG. 5a, the apparatus/device 500 is displaying a list of journals 504 as a list of journal indicators 506, 512, 518 available for viewing on the device 500. The journals may be stored on a memory of the apparatus/device 500 or may be stored remote to the apparatus/device 500 and may be accessed by the apparatus/device 500.

The apparatus has enabled the creation of a discrete journal (in this example, at least three discrete journals) comprising time-stamped user event content taken from a plurality of user applications. For example, the “Front Row” journal for a rock concert which the user attended, indicated by journal indicator 512 includes photographs, movies, social media status updates and location logs. Each discrete journal relates to a discrete journal timeframe (not shown in FIG. 5a). The time-stamped user event content has time-stamps within the discrete journal timeframe; thus the photographs in the “Front Row” journal have time stamps (e.g. were taken/recorded) within the discrete “Front Row” journal timeframe. The journal timeframe for the “Front Row” journal may be 6 pm Saturday 16 Jun. 2012 to 2 am Sunday 17 Jun. 2012. Photographs (and other user event content) timestamped with a time stamp within the timeframe of Saturday 16 Jun. 2012 to 2 am Sunday 17 Jun. 2012 may be included in the “Front Row” journal.

Three journals are currently being displayed/indicated on screen via the display of three journal indicators 506, 512, 518. It may be that more than three journals are available for viewing and/or interaction, and the user of the device 500 may be able to, for example, perform a user gesture on the touch-sensitive screen on the device 500 to slide a finger up the screen and reveal other journal indicators. Journal indicator 506 is entitled “Recent” 510 and is displaying an associated image 508 of some trees. Journal indicator 512 is entitled “Front Row” 516 and is displaying an associated image 514 of a singer in a band. Journal indicator 518 is entitled “London” 522 and is displaying an associated image 520 of a London landmark. Other content which may be included in other exemplary journal indicators includes an icon, a button, banner or menu option taken from or respectively formed using the user event content which is associated with the journal being indicated, a button, a banner, and a menu option. Each image 508, 514, 520 labelled with a textual label 510, 516, 522 in FIG. 5a may be considered to be a banner journal indicator 506, 512, 518.

The relative size of the journal indicator 506, 512, 518 for each discrete journal in FIG. 5a corresponds to the amount of time-stamped user event content associated with the discrete journal. That is, there are more items of time-stamped user event content associated with the “London” journal than with the “Front Row” and with the “Recent” journals, since the journal indicator 518 for the “London” journal is larger than journal indicators 506, 512.

In other examples, the relative size of the journal indicator for each discrete journal may corresponds to the amount of user activity associated with the discrete journal. For example, if a user selects, reads, edits, transmits or otherwise interacts with a journal more often, the associated journal indicator may be displayed as a larger sizes indicator. In other examples, the relative size of the journal indicator for each discrete journal may corresponds to the journal timeframe of the discrete journal, and a longer discrete journal timeframe may give rise to a larger associated journal indicator, for example. In other examples, the relative size of the journal indicator for each discrete journal may correspond to a predefined user setting associated with the journal; that is, a user may be able to select a particular journal as a “favourite” and the corresponding journal indicator may appear larger for a “favourite” journal than for other “non-favourite” journals. A favourite journal may also be indicated, for example by a star displayed on the favourite journal indicator.

The relative size of a journal indicator may depend upon a combination of factors such as those listed above.

FIG. 5b illustrates a journal indicator 550 displayed on the screen of a portable electronic device 500. The journal indicator 550 is displayed over the entire screen area except for the area used by the status bar 502. The journal indicator 550 has an image 524, a textual label “London” 526, and also indicates the discrete journal timeframe 528, 530 of the journal associated with the journal indicator. The length of time in days 528 of the discrete journal timeframe of the journal is displayed, as is the time period 530 (the start and end time points) of the associated journal.

The journals associated with the journal indicators 506, 512, 518, 550 are discrete journals comprising time-stamped user event content taken from a plurality of user applications. Each discrete journal relates to a discrete journal timeframe (for example, the period in days 528 or the defined journal timeframe 530 in FIG. 5b), and the time-stamped user event content associated with the indicated journals has time-stamps within the discrete journal timeframe. Therefore, the time-stamped user event content associated with the “London” journal indicated in FIG. 5b is content time-stamped with a time/date within the timeframe of 6-8 Nov. 2011.

FIG. 5b also shows that the journal indicator includes information on the number of contacts 532 associated with the journal, the number of photographs 534 in the journal, the number of messages 536 in the journal, and the number of locations listed 538 in the journal. These elements are icons formed from the user event content in the journal. That is, for example, the number of photographs within the journal has been automatically determined as 95, so the number “95” is displayed in the journal indicator 550 next to a photograph icon 534 in the journal indicator.

Contacts associated with the journal may include contacts to whom e-mails/SMS/MMS messages were sent, or from whom e-mails/SMS/MMS messages were received, contacts who were mentioned in social media posts made within the journal timeframe 530 and included as user event content in the journal, contacts who were labelled as being in photographs in the journal, and newly-created contacts, for example.

Photographs in the journal may be photographs which were taken using the apparatus/device 500 having a time-stamp (within the journal timeframe 530). Therefore all photos taken (and time-stamped) on 6, 7 and 8 Nov. 2011 may be included in the journal to make up the 95 photographs 534 in the journal. The user may have received photographs sent by contacts in e-mail or MMS messages within the journal timeframe 530, and such photographs may also be included in the journal. In other examples, only photographs taken using the apparatus 500 may be included in the photographs in the journal and any other photographs such as those received in messages may not be included. The inclusion of particular content and exclusion of other content in journals may be determined according to a predetermined setting of the apparatus, or may be determined according to user preferences of the apparatus.

The number of messages in the journal 536 may include messages sent and/or messages received and/or messages composed (but not sent, for example, those saved as draft messages). Messages may include SMS, MMS, e-mail, social media status posts, blog/microblog entries made, RSS feeds received/read, and other message types.

The locations included in the journal may be locations which have been logged by the user of the apparatus/device 500 during the discrete timeframe 530. Locations may be logged, for example, by: a user manually entering a location into the device during the journal timeframe 530; by a user selecting to register a location determined within the journal timeframe 530 via GPS location circuitry and a suitable application of the apparatus/device; or by a user using a location name (e.g. Hyde Park, Buckingham Palace, Kensington) in a message such as an SMS message within the journal timeframe 530 which is automatically detected as a location name. Other ways in which a location may be recorded with a particular time-stamp may be envisaged.

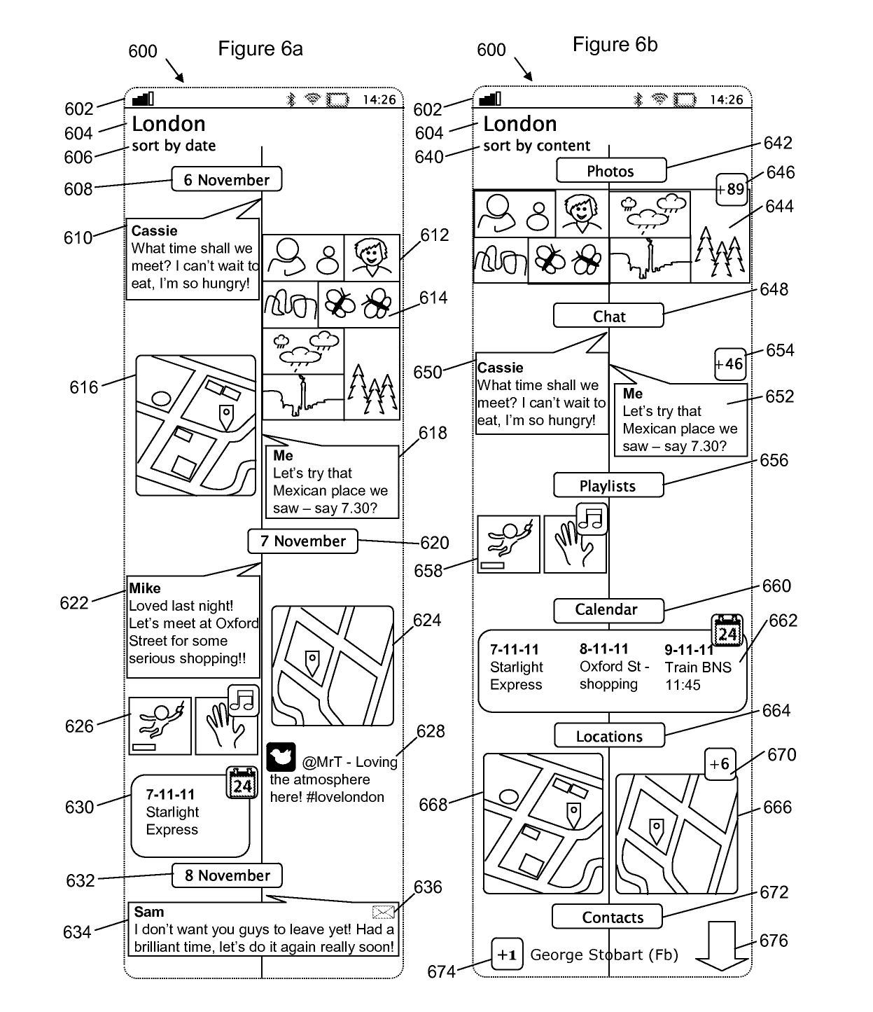

FIGS. 6a-6b illustrate an example of an apparatus 600 in use. The apparatus 600 may be a portable electronic device, a mobile telephone, a smartphone, a tablet computer, a personal digital assistant, a laptop computer, a media player, a non-portable electronic device, or a desktop computer, provided the apparatus has a display screen on which to display the journal. Specifically, the examples illustrated in FIGS. 6a-6b are of a journal displayed on the display screen of a portable electronic device 600 such as a smartphone. The apparatus is thus configured to enable time-stamped user event content to be displayed in a discrete journal timeframe on an electronic device 500.

The apparatus/device 600 is displaying a status bar 602 including exemplary information such as the received signal strength (in the examples of telephone devices), Bluetooth® connectivity, battery power remaining, and the current time. The device 600 is also displaying at least a portion of a discrete journal.

The apparatus/device 600 in FIGS. 6a and 6b is configured to allow a user to select the particular user applications from which the discrete journal will be created. Therefore the user is able to select which user applications are included in the list of applications from which associated user event content can be taken for populating the journal. The user may wish to, for example, include photographs, movies, locations and contacts in a journal but may not wish to include, for example, playlists, social media updates, chat messages or blog posts in the journal. The user has the option of selecting/deselecting the appropriate associated user applications so that only particular types of user event content are included. The user may be able to change these preferences at any time and the journal may be able to re-populate with the corresponding time-stamped user event content according to the user's new preferences.

FIG. 6a illustrates time-stamped user event content 610, 612, 614, 616, 618, 622, 624, 626, 628, 630, 634 displayed within the discrete journal timeframe, the time-stamped user event content being chronologically grouped according to the time stamp of the time-stamped user event content independent of the particular application from which the user event content was obtained.

Thus, the journal illustrated in FIG. 6a relates to a user's visit to London 604 and the user event content is sorted according to the date 606 (that is, according to the timestamp of each item of time-stamped user event content). On 6 November 608 a received message 610, seven photographs, a location 616 and a transmitted message 618 are included and displayed in the journal. The seven photographs are displayed as a composite preview image 612 of the individual photographs (e.g. 614). In other examples each photograph may be displayed separately. The location 616 is displayed on a map, but in other examples the location name may be listed instead (or as well as the map being displayed). In this example the user event content is organised according to the timestamp in that all the content 610, 612, 616, 618 was timestamped as “6 November”.

Also in this example, each item of user event content 610, 612, 616, 618 is organised according to the specific time of the timestamp, thus first the message from Cassie was received 610, then the user took some photographs 612, then the user logged their location 616, and finally the user replied to Cassie's message 618. In other examples on a particular date (such as 6 November) user event content relating to the same user application may be grouped together; that is, the message from Cassie 610 may be displayed immediately before the reply 618 even though the photographs were taken and the location was logged in-between the timestamps of the two messaging events 610, 618.

On 7 November 620 the user received a message from Mike 622, logged their new location 624, listened to a music playlist 626, posted a microblog entry 628, and then their calendar indicated that they have an event recorded in their calendar 630 (in this example, to attend a performance of Starlight Express). On 8 November 632 the user received an e-mail 634 from Sam. Different types of message may be depicted in different ways. For example, an SMS message may be shown as a speech bubble 610, 618, 622, whereas an e-mail 634 may be shown as a speech bubble with an envelope icon 636. In other examples all types of textual message may be shown in a journal in the same way.

The photographs 612, 614 are timestamped according to when they were taken. For

SMS messages 610, 618, 622, blog posts 628 and e-mail messages 636 the time stamp of each message is according to when each message was received or transmitted. For locations on maps, the time-stamp of the location user event content is when the location was logged (for example, the apparatus may be GPS location capability and the use may log their location using the GPS location capability; upon logging the location, the time of logging is also recorded to provide a time stamp). For playlists, the time stamp may be the last time when the playlist, or part of the playlist, was listened to, or modified (e.g. albums added or removed to the playlist) by the user. For calendar entries, the time stamp may be the time/date of the calendar entry (for example, a calendar entry for “Meeting 2 pm 6/10/12” may have the time stamp of 2 pm, 6 Oct. 2012).

FIG. 6b illustrates time-stamped user event content 644, 650, 652, 658, 662, 666, 668, 674 displayed within the discrete journal timeframe, the time-stamped user event content being time-stamped in groupings 642, 648, 656, 660, 664, 672 according to the particular user event content type independent of the particular application from which the user event content was obtained.

Again, the user has a discrete journal about a visit to London, so the journal is titled “London” 604 and is sorted by content 640 (but not in this example by individual user application type associated with the content). The order in which the content type is provided to the user (e.g. chronologically, by application type) may be a default setting or may be changed by the user in a user preferences menu, for example.

The journal includes “Photos” 642, “Chat” 648, “Playlists” 656, “Calendar” 660, “Locations” 664 and “Contacts” 672. Regarding photographic user event content, a preview of the photos 644 included in the journal is shown and an indication of the total number of photos 646 (in this example, 89) in the journal is shown. It may be imagined that the user can select to view all the photos in the journal (for example by tapping the “Photos” label 642 or the number indicator 646). Under “Chat” 648, the latest two chat messages 650, 652 are shown but there are a total of 46 chat messages recorded in the journal as indicated by the chat indicator 654. The latest two chat messages are identified by the associated timestamps of the chat messages. For “Playlists” 656, the playlist is indicated 658. For “Calendar” 660, a representation of the calendar entries 662 timestamped as within the timeframe of the discrete journal are shown. It may be that there are more than three calendar entries timestamped as within the discrete journal timeframe, and for example, the user may be able to scroll left and right to view earlier and later calendar entries in the journal. For “Locations” 664, two 666, 668 of a total of six 670 locations are indicated. One contact 674 is indicated under “Contacts” 672. This contact may be a new contact entry made, or updated, during the timeframe of the discrete journal.

There may be further contacts, and/or other user event content categories which the user may view by scrolling down on the display screen, for example using a scroll arrow 676, scroll bar, slide user gesture, or any other appropriate user input as known in the art.

The user event content shown in FIGS. 6a and 6b is exemplary to illustrate some possible types of user event content which may be taken for inclusion in a discrete journal. Other user event content which may be included in a discrete journal includes movies (such as movies recorded by the user), status updates (such as updates posted to a social media website), website posts (such as comments posted in an online forum), game-related content (such as unlocking a new level in a game or completing a game), and bookmarks (such as creating or moving a bookmark in an electronic book, magazine, website or other document).

In other examples, the time-stamped user event content may be displayed within the discrete journal timeframe, with the time-stamped user event content being time-stamped in groupings according to the particular application from which the user event content was obtained. For example, it may be imagined that if two user applications were available and associated with the display of a location (such as those illustrated as elements 616, 624, 666, 668) then the location label 664 may be replaced by two separate “location app A” and “location app B” labels, for example, with the corresponding location user event content organised under each respective corresponding label.

In other examples the time-stamped user event content may be displayed within the discrete journal timeframe with all the time-stamped user event content being displayed item by item. Therefore, rather than displaying a representative selection of all the photographic user event content in a particular discrete journal (for example as shown in FIG. 6b in relation of “photos” where a summary of the “89” available photos 646 is displayed), all 89 photos may be displayed and the user may be able to, for example, scroll through the photos on the display screen. Scrolling may be up-down, or may be left-right so that other user event content types are not removed from display during browsing of the 89 photos. It may be envisaged that the user can expand the summary of photos 642 shown in FIG. 6b by, for example, tapping the “+89” icon 646 to display all 89 photos, and may be able to reduce the 89 displayed photos to a summary again, for example by double tapping the “photos” label 642. Of course, many other ways in which a summary display/full content display may be toggled are known in the art and included in this disclosure.

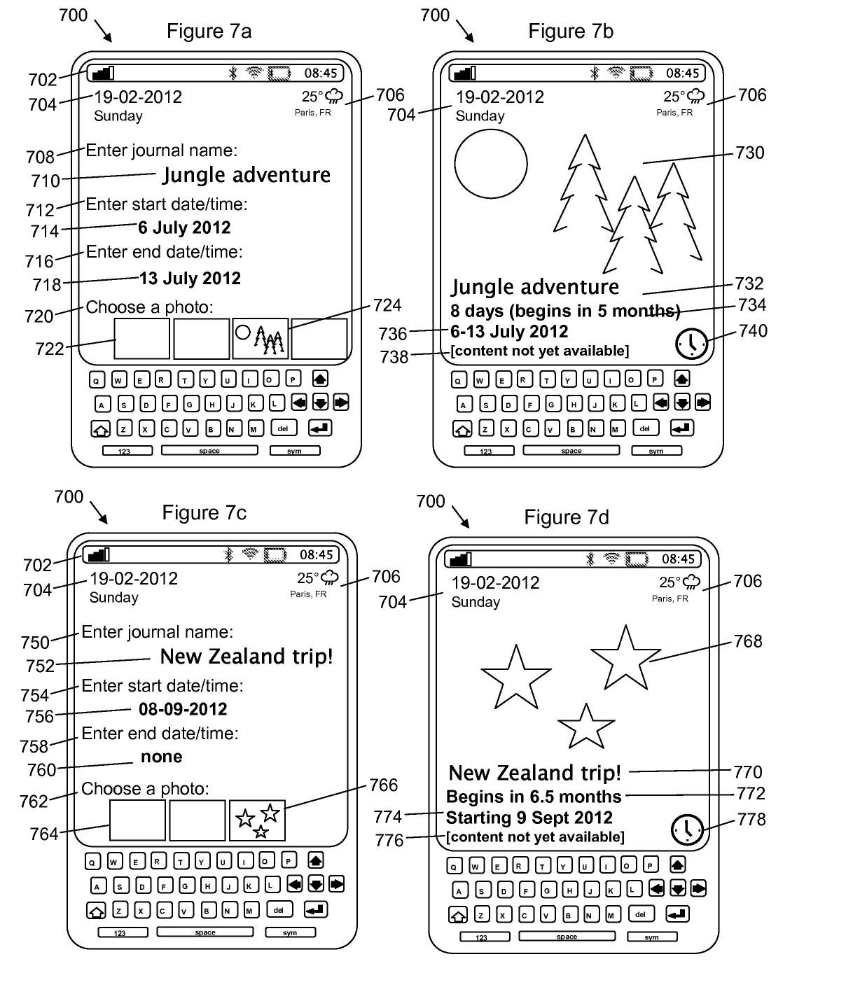

FIGS. 7a-7b illustrate an example of an apparatus 700 in use. The apparatus may be, for example, a portable electronic device, a mobile telephone, a smartphone, or a PDA. Functionality other than that directly associated with a journal is indicated in a status bar 702, such as, for example, signal strength, battery power remaining, connectivity, and the current local time. Also indicated are other example indications not directly associated with the journal including the current day and date 704, and the local weather conditions and location detected by the apparatus 706. These examples serve to illustrate that the apparatus may have much greater functionality than just compiling and displaying journals. For example, a mobile telephone may have telephonic (calling and messaging) functionality, clock, GPS location capability, internet-access capability, as well as being able to enable the creation of a discrete journal comprising time-stamped user event content taken from a plurality of user applications. The plurality of user applications may be stored on a local memory of the apparatus, or they may be stored remotely from the apparatus. Some (including one or more) of the plurality of applications may be stored locally and others (including one or more) may be stored (and for example, run) remotely but still be accessible to the apparatus in other examples. The same may be true with regard to the storage of the user event content, in that the user event content could be stored locally or remotely and be distributed across a number of apparatus/devices.

FIGS. 7a and 7c illustrate a discrete journal timeframe being defined according to a user indicated discrete timeframe. In FIG. 7a, the discrete journal timeframe is defined according to user indicated start 714 and end 718 time points.

FIGS. 7a and 7c may be considered to illustrate that the discrete journal timeframe is defined according to a user indication which provides one or more discrete time points. In FIG. 7a the user indicates a start time point 714 and an end time point 718. In FIG. 7c, the user indicates a start time point 756 only, and will define an end time point at a later date. These time points 714, 718, 756 define discrete timeboundaries to encompass events which occur within the discrete timeboundaries, in the life of a user.

FIG. 7a shows that a user is setting up a new discrete journal timeframe. The user is invited to enter a journal name 708, and has entered “Jungle adventure” 710. The user is invited enter a start date/time 712 and has entered the 6 Jul. 2012 as a start date 714. The user is also invited enter an end date/time 716 and has entered the 13 Jul. 2012 as an end date 718. In this example the user is also invited to choose a photo 720 which will be used in the journal indicator. The user chooses a photo 724 from a provided selection of photos 722. In other examples, the apparatus may automatically determine a photo for use in the corresponding journal indicator (e.g. taken from the user event content which will populate the journal).

FIG. 7b shows the journal indicator for this defined discrete journal. The chosen photograph 730 is used in the journal indicator. The journal name 732 is displayed. The apparatus has calculated, based on the entered start 714 and end 718 dates, that the discrete journal timeframe is 8 days long, and that it is due to start (that is, the defined start date 714 will occur) in five months time 734. The selected start 714 and end 718 dates are indicated 736 in the journal indicator. Because the user has selected a journal timeframe which lies in the future, this future journal timeframe is indicated by a clock icon 740 and by the message “[content not yet available]” 738. There is no user event content available to the apparatus with which to populate the journal since the journal timeframe is in the future. However, the journal has still been created by the user ready for when the start date 714 arrives.

Therefore, the apparatus/device 700 is configured to enable the creation of the discrete journal by receipt of an indication of a future discrete journal timeframe 736, the future discrete journal timeframe 736 being associated with a time period in the future with respect to the time 704 at which the indication is received. The user is providing a start 714 and end 718 date for the journal, which are associated with dates (6 and 13 Jul. 2012) in the future compared with the time and date (19 Feb. 2012 704) at which the start and end date information is received by the apparatus/device 700.

The apparatus/device 700 is configured to automatically populate the discrete journal with time-stamped user event content taken from a plurality of user applications upon commencement of the indicated future discrete journal timeframe. Thus, five months after creation of the journal (as indicated 734) the journal will start to be automatically populated with user event content timestamped with a timestamp within the timeframe 736 of the journal. The apparatus/device 700 is configured to populate the discrete journal with the time-stamped user event content upon detection of the availability of the time-stamped user event content within the discrete journal timeframe. Thus as the user event content is recorded/stored and made available for use by the apparatus, it can be taken and used to populate the journal provided it is timestamped with a time within the discrete journal timeframe.

Upon completion of the indicated future discrete journal timeframe, that is, after 13 Jul. 2012 the apparatus/device 700 is configured to automatically complete population of the discrete journal with the time-stamped user event content taken from the plurality of user applications. Thus, after the 13 Jul. 2012, no more user event content will be timestamped with a timestamp within the journal timeframe and population of the journal will be completed.

FIG. 7c, similarly to FIG. 7a, shows that a user is setting up a new discrete journal timeframe. The user is invited to enter a journal name 750, and has entered “New Zealand trip!” 752. The user is invited to enter a start date/time 754 and has entered the 8 Sep. 2012 as a start date 756. The user is also invited to enter an end date/time 758 but the user has not, in this example, entered an end date/time. The user has entered “none” 760. Therefore this journal is an open-ended journal with a timeframe such as that illustrated in FIG. 4 by element 480. The user is also invited to choose a photo 762 which will be used in the journal indicator, and has chosen a photo 726 from a provided selection of photos 764.

The user in this example is able to provide an end date for the journal at a later date. This later date may be before the commencement of the journal timeframe, or after the commencement of the journal timeframe (and after population of the journal with user event content has begun).

FIG. 7d, similarly to FIG. 7b, shows the journal indicator for this defined discrete journal. The chosen photograph 768 is used in the journal indicator. The journal name 770 is displayed. The apparatus has calculated, based on the entered start 756 that the discrete journal timeframe is due to start (that is, the defined start date 756) in six-and-a-half months time 772. Since no end date has yet been specified for this journal, rather than indicating a timeframe as in FIG. 7b, the apparatus displays the starting date of the journal 774. Because the user has selected a journal timeframe which lies in the future (as it begins in the future), this future journal timeframe is indicated by a clock icon 778 and by the message “[content not yet available]” 776. Again, there is no user event content available to the apparatus with which to populate the journal since the journal timeframe is in the future. However, the journal has still been created by the user ready for when the start date 756, 774 arrives.

Thus, the apparatus/device 700 of FIGS. 7c-7d is configured to enable the creation of the discrete journal by receipt of an indication of a future discrete journal timeframe 756 (in this case, a start of the journal timeframe). The future discrete journal timeframe beginning at a particular date 756, 774 is associated with a time period in the future with respect to the time 704 at which the indication is received. The user is providing a start 756 date for the journal, which is associated with a date (9 Sep. 2012) in the future compared with the time and date (19 Feb. 2012 704) at which the start date information is received by the apparatus/device 700.

The apparatus/device 700 is configured to automatically populate the discrete journal with time-stamped user event content taken from a plurality of user applications upon commencement of the indicated future discrete journal timeframe. Thus, six-and-a-half months after creation of the journal (as indicated 772) the journal will start to be automatically populated with user event content timestamped with a timestamp within the journal timeframe (i.e. on or after 9 Sep. 2012) of the journal. The apparatus/device 700 is configured to populate the discrete journal with the time-stamped user event content upon detection of the availability of the time-stamped user event content within the discrete journal timeframe. Thus as the user event content is recorded/stored and made available for use by the apparatus, it can be taken and used to populate the journal provided it is timestamped with a time within the discrete journal timeframe.

Upon completion of the indicated future discrete journal timeframe, the apparatus/device 700 will be configured to automatically complete population of the discrete journal with the time-stamped user event content taken from the plurality of user applications. Before this, however, an end date must be specified for the journal in order for the end of the journal timeframe to be defined. Thus after the to-be-specified end date, no more user event content will be timestamped with a timestamp within the journal timeframe and population of the journal will be completed.

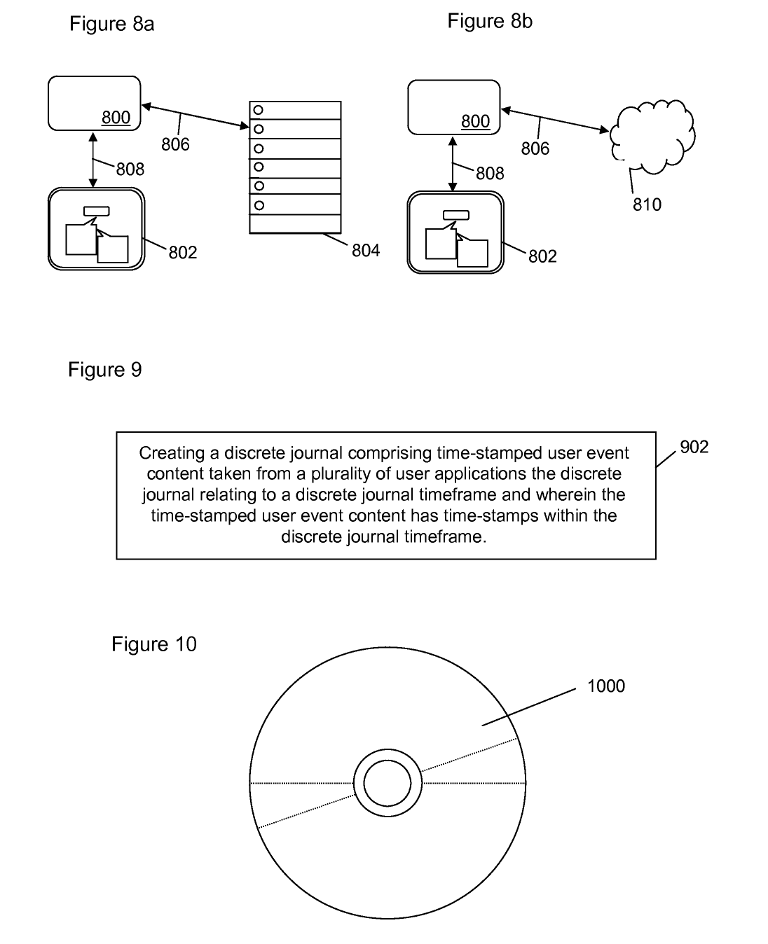

FIG. 8a shows that the apparatus is in communication with a remote server. FIG. 8b shows that the apparatus is in communication with a “cloud” for cloud computing. In FIGS. 8a and 8b, apparatus 800 (which may be apparatus 100, 200 or 300) is in communication with 808 a display 802 displaying a journal. Of course the apparatus 800 and display 802 may form part of the same apparatus/device, although they may be separate as shown in the figures. The apparatus 800 is also in communication 806 with a remote computing element. Such communication may be via a communications unit 250, for example. FIG. 8a shows the remote computing element to be a remote server 804, with which the apparatus may be in wired or wireless communication (e.g. via the internet, Bluetooth®, a USB connection, or any other suitable connection as known to one skilled in the art). In FIG. 8b, the apparatus 800 is in communication with a remote cloud 810 (which may, for example, by the Internet, or a system of remote computers configured for cloud computing). It may be that the journal and/or at least some user event content and/or at least some user applications are stored/run at the remote computing element 804, 810 and accessed by the apparatus 800 for display 802 as a journal. The user applications and user event content need not all be stored at the same location. Some or all of the user applications and/or user event content may be stored at the apparatus 100, 200, 300, 800. Some or all of the user applications and/or user event content may be stored at the remote computing element 804, 810. The apparatus 800, 802 may actually form part of the remote sever 804 or remote cloud 810.

FIG. 9 shows a flow diagram illustrating a method of creating a discrete journal comprising time-stamped user event content taken from a plurality of user applications the discrete journal relating to a discrete journal timeframe and wherein the time-stamped user event content has time-stamps within the discrete journal timeframe 902 and is self-explanatory.

FIG. 10 illustrates schematically an example comprising a computer/processor readable medium 1000 providing a computer program. In this example, the computer/processor readable media is a disc such as a digital versatile disc (DVD) or a compact disc (CD). In other examples, the computer readable media may be any media that has been programmed in such a way as to carry out an inventive function.

The terms “journal” and “discrete journal” are used interchangeably in this disclosure, such that references to a journal imply that the journal is a discrete journal with a particular timeframe. Also, user event content in this disclosure should be taken to be time-stamped user event content, even if it is not explicitly labelled as being time-stamped.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description it will be evident to a person skilled in the art that various modifications may be made within the scope of the disclosure.

While there have been shown and described and pointed out fundamental novel features of the disclosure as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or example of the disclosure may be incorporated in any other disclosed or described or suggested form or example as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
enable the creation of a discrete journal comprising time-stamped user event content taken from a plurality of user applications, the discrete journal relating to a discrete journal timeframe and wherein the time-stamped user event content has time-stamps within the discrete journal timeframe.

2. The apparatus of claim 1, wherein the discrete journal timeframe is defined according to a user indicated discrete timeframe.

3. The apparatus of claim 1, wherein the discrete journal timeframe is defined according to a user indication which provides one or more discrete time points which define a discrete timeboundary to encompass events which occur within the discrete timeboundary, in the life of a user, the events being captured by one or more of the plurality of user applications to provide time-stamped user event content.

4. The apparatus of claim 1, wherein the apparatus is configured to enable the creation of the discrete journal by receipt of an indication of a future discrete journal timeframe, the future discrete journal timeframe associated with a time period in the future with respect to the time at which the indication is received.

5. The apparatus of claim 4, wherein the apparatus is configured to automatically populate the discrete journal with the time-stamped user event content taken from the plurality of user applications upon commencement of the indicated future discrete journal timeframe.

6. The apparatus of claim 4, wherein the apparatus is configured to automatically complete population of the discrete journal with the time-stamped user event content taken from the plurality of user applications upon completion of the indicated future discrete journal timeframe.

7. The apparatus of claim 1, wherein the apparatus is configured to automatically populate the discrete journal with the time-stamped user event content taken from the plurality of user applications upon commencement of the discrete journal timeframe.

8. The apparatus of claim 1, wherein the apparatus is configured to populate the discrete journal with the time-stamped user event content upon detection of the availability of the time-stamped user event content within the discrete journal timeframe.

9. The apparatus of claim 1, wherein the apparatus is configured to detect that the location of the apparatus has changed beyond a predetermined threshold, and upon detection, offer an option to a user to create a new discrete journal.

10. The apparatus of claim 1, wherein the apparatus is configured to detect that the amount of time-stamped user event content made newly available to the apparatus in a predetermined period is higher than a predetermined threshold, and upon detection, offer an option to a user to create a new discrete journal having a journal timeframe including the predetermined period.

11. The apparatus of claim 1, wherein the apparatus is configured to organise the time-stamped user event content within the discrete journal timeframe by one or more of:
time-stamped in groupings according to the particular user event content type independent of the particular application from which the user event content was obtained;
time-stamped in groupings according to the particular application from which the user event content was obtained; and
chronologically grouped according to the time stamp of the time-stamped user event content independent of the particular application from which the user event content was obtained.

12. The apparatus of claim 1, wherein the discrete journal is one of a plurality of discrete journals, each of the plurality of discrete journals having at least partially different journal timeframes associated with a particular user.

13. The apparatus of claim 1, wherein the time-stamped user event content is time-stamped according to at least one of the time of creation, receipt, transmission, modification and/or sharing of the time-stamped user event content.

14. The apparatus of claim 1, wherein the time-stamped user event content type is one or more of: a photograph, a movie, a sent or received short message, a sent or received e-mail, a sent or received chat message, a music file, a created file, a saved file, a status update, a website post, contact information, game-related content, a playlist, a calendar entry, a map location, and a bookmark.

15. The apparatus of claim 1, wherein the apparatus is configured to indicate a discrete journal by displaying a journal indicator, the journal indicator comprising one or more of an image, a textual label, an icon, a button, banner or menu option taken from or respectively formed using the user event content, or an icon, a button, a banner, an image, a textual label and a menu option.

16. The apparatus of claim 15, wherein the apparatus is configured such that the relative size of the journal indicator for a discrete journal corresponds to one or more of:
the amount of time-stamped user event content associated with the discrete journal;
the amount of user activity associated with the discrete journal;
the journal timeframe of the discrete journal;
an indicated importance level of the discrete journal; and
a predefined user setting associated with the journal.

17. The apparatus of claim 1, wherein the apparatus is configured to enable transmission of the discrete journal to a remote electronic device.

18. The apparatus of claim 1, wherein the apparatus is configured to create the journal by the apparatus or by an apparatus remote to the apparatus.

19. The apparatus of claim 1, wherein the apparatus is a portable electronic device, a mobile telephone, a smartphone, a tablet computer, a personal digital assistant, a laptop computer, a media player, a non-portable electronic device, a desktop computer, a server, or a module/circuitry for one or more of the same.

20. A method comprising:
creating a discrete journal comprising time-stamped user event content taken from a plurality of user applications the discrete journal relating to a discrete journal timeframe and wherein the time-stamped user event content has time-stamps within the discrete journal timeframe.

21. Computer program code configured to:
enable the creation of a discrete journal comprising time-stamped user event content taken from a plurality of user applications, the discrete journal relating to a discrete journal timeframe and wherein the time-stamped user event content has time-stamps within the discrete journal timeframe.
